(19) United States
(12) Patent Application Publication
(10) Pub. No.: US 2025/0234834 A1
(43) Pub. Date: Jul. 24, 2025

(54) ANIMAL TRANSPORT

(71) Applicant: Christopher Alan Burton, Wellington, CO (US)

(72) Inventor: Christopher Alan Burton, Wellington, CO (US)

(21) Appl. No.: 18/419,912

(22) Filed: Jan. 23, 2024

(51) Int. Cl. A01K 1/02

(52) U.S. Cl. CPC A01K 1/0272

(57) ABSTRACT

A pet compartment includes a base, a plurality of frames, a canopy, a number of automobile anchor connectors and a tether connector. The frames include leg portions pivotably coupled with opposing sides of the base near a rear side of the base and bridge portions spanning the leg portions. The canopy is supported by the frames so as to fold and unfold upon relative pivoting of the frames. The automobile anchor connectors are coupled with the base at the rear side. The tether connector coupled with the bridge of one of the frames.

### SUMMARY

The disclosure describes a pet compartment. The pet compartment includes a base, a plurality of frames, a canopy, a number of automobile anchor connectors and a tether connector. The frames each include leg portions pivotably coupled with opposing sides of the base near a rear side of the base and bridge portions spanning the leg portions. The canopy is supported by the frames so as to fold and unfold upon relative pivoting of the frames. The automobile anchor connectors are coupled with the base at the rear side. The tether connector coupled with the bridge of one of the frames.

The disclosure also describes a pet enclosure. The pet enclosure includes a base, a collapsible canopy configured for suspending above the base, a number of automobile anchor connectors configured for coupling with the base at the rear side and a tether connector configured for coupling with the collapsible canopy.

Further, the disclosure describes a method for producing a pet transport cubicle. A number of hexagons are cut from a nylon mesh such that each of three forward edges and three rearward edges of each hexagon includes a sleeve-forming flap. A rod is sewn into a sleeve formed from each of the flaps of the three rearward edges to form a frame for each of the hexagons. The hexagons are sewn together at the forward and rearward edges while leaving one free forward edge and one free rearward edge. The three sewn hexagons are formed into a canopy having two generally flat side surfaces and a faceted arch top surface. A base is provided. The sewn hexagons are pivotably coupled to opposing sides of the base near a rear side thereof such that there is a forward hexagon, a center hexagon and a rearward hexagon. First and second automobile anchor connectors are coupled with the base at a rear side near corners thereof. A tether connector is coupled with a bridge of the frame of the rearward hexagon.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a perspective view of an example pet compartment.

FIG. 2 illustrates a right side view of the example pet compartment of FIG. 1.

FIG. 3 illustrates a rear view of the example pet compartment of FIGS. 1 & 2.

FIG. 4 illustrates a front view of the example pet compartment of FIGS. 1-3.

FIG. 5 illustrates a top view of the example pet compartment of FIGS. 1-4.

FIG. 6 illustrates a right side view of the example pet compartment of FIGS. 1-5 in a collapsed state.

FIG. 7 illustrates a perspective view of an example sleeve or pocket suitable for use in association with disclosed pet compartments.

FIG. 8 illustrates a top view of an example unfolded section of canopy suitable for use in association with disclosed pet compartments.

FIG. 9 illustrates a detail, side view of an example automobile anchor connector suitable for use in association with disclosed pet compartments.

FIG. 10 illustrates a detail, side view of an example tether connector suitable for use in association with disclosed pet compartments.

FIG. 11 illustrates a hidden lines side view of an example pet compartment as installed in an automobile.

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Pets are commonly transported in automobiles by placing in a cargo compartment in an SUV, by placing loosely on an automobile seat or by carrying in an operator's lap. With the pet loosely placed into the automobile, there is significant risk of the pet being thrown around the vehicle during sudden acceleration, deceleration or sharp turns. Even when pets are housed in a carrier prior to placing into an automobile, the carrier may be thrown around the vehicle in these same situations.

Embodiments of the disclosure substantially eliminate, or at least partially address, problems in the prior art, enabling a user to transport a pet or other small animal in or on an automobile seat in a manner that is safe for both the user and the pet while preventing damage to the automobile interior from stains and/or tears. Disclosed methods and embodiments may be suitable for supporting transport of any of a variety of pets or small animals including but not limited to dogs, cats, reptiles, birds, rodents or rabbits.

Additional aspects, advantages, features and objects of the disclosure will be made apparent from the drawings and the detailed description of the illustrative embodiments construed in conjunction with the appended claims that follow.

It will be appreciated that features of the disclosure are susceptible to being combined in various combinations without departing from the scope of the disclosure as defined by the appended claims.

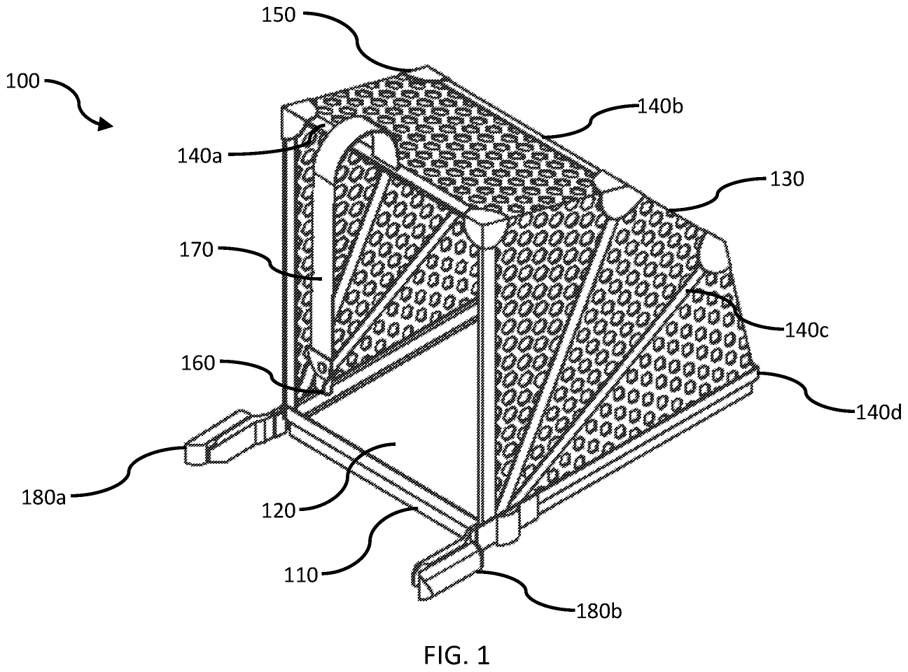

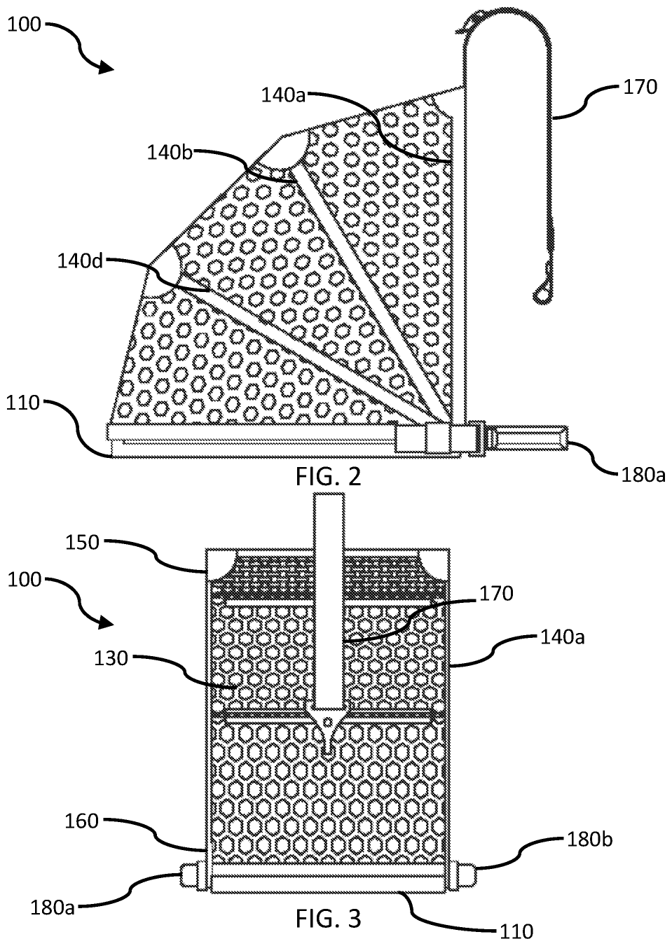

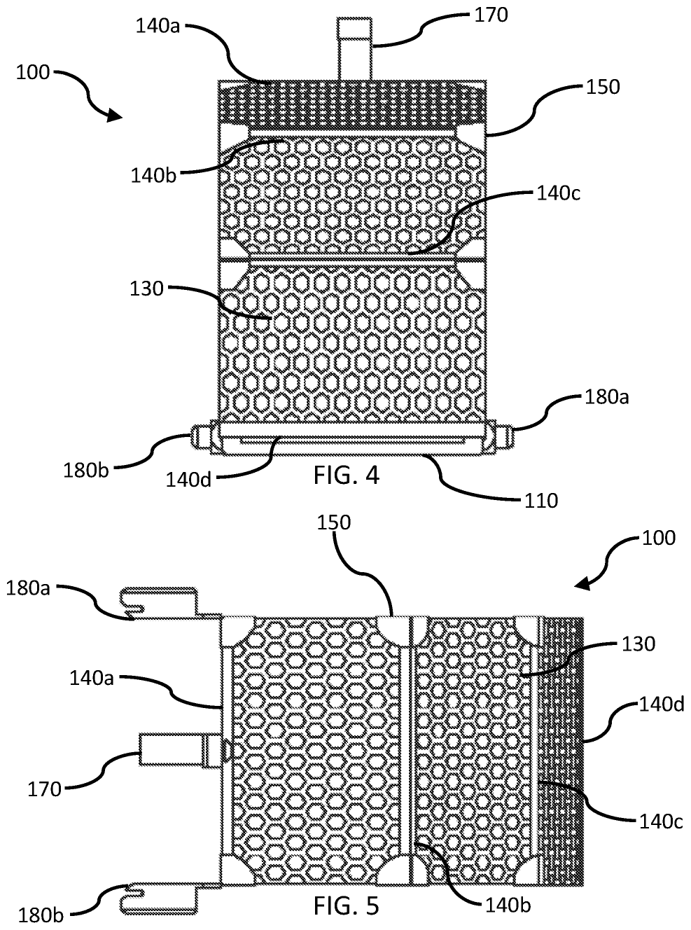

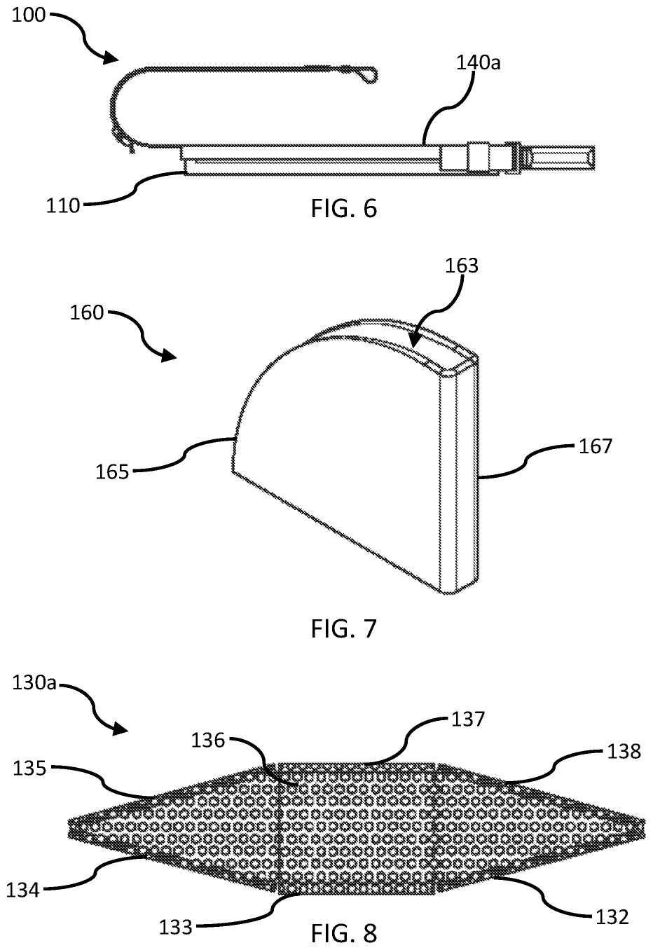

FIGS. 1-5 illustrate an example pet cubical, enclosure or compartment 100 in an unfolded or expanded state while FIG. 6 illustrates the example pet compartment of FIGS. 1-5 in a collapsed state. Pet compartment 100 includes a base 110, a number of ribs or frames 140a, 140b, 140c and 140d (collectively, 140), a canopy 130, a number of automobile anchor connectors 180a, 180b and a tether connector 170.

Base 110 may take any shape suitable for placing on a seat of an automobile for anchoring to the seat. In an example, base 110 is polygonal. In a further example, base 110 is rectangular. Similarly, base 110 may take any dimensions suitable for placing on the seat of an automobile. In an example, base 110 exhibits a width of 16″ and a length of 22″. Base 110 may be formed from any of a variety of lightweight, relatively rigid, supportive materials including but not limited to plastic.

Pet compartment 100 may further include a foam pad 120 contained by base 110. A zippered sleeve may be provided surrounding pad 120 for removal and washing or cleaning in the event of soiling or staining.

Canopy 130 is collapsible and configured for supporting or suspending above base 110, for example, by frames 140 so as to unfold or expand upon relative pivoting of frames 140 in a first direction and to fold or collapse upon relative pivoting of the ribs in a second, opposite direction.

Frames 140 include leg portions pivotably coupled to opposing sides of base 110 near a rear side of base 110 and bridge portions spanning the leg portions and the width of base 110. Frames 140 may have a common pivot axis or may rotate as though they have a common pivot axis. In an example, the leg portions of frames 140 are coupled to the sides of base 110 by a sleeve or pocket joint 160 (FIG. 7) in the form of a circular segment which constrains the leg portions to generally pivoting within a plane of the leg portions and within an arc 165 of approximately 90 degrees. By its approximate 90-degree sweep, arc 165 may sweep through between perhaps 87 degrees and 93 degrees and will otherwise appear to sweep through 90 degrees to an ordinary observer. Circular segment pocket 160 may be open along the arc and a straight bottom edge at 163 while being closed along a rear straight edge 167 defining one limit of the arc.

The pet compartment may include any number of frames 140 suitable for securely supporting canopy 130 above base 110. In an example, there are four frames—one passive frame 140d resting or confined to base 110 and three active frames configured for pivoting between base 110 and an angle dictated by the position at which they are affixed to canopy 130. Frames 140 may be coupled with canopy 130 at a variety of points along a front-to-rear length thereof.

Pivoting of each of frames 140 may be limited according to the number of frames and where each frame is coupled along the front-to-rear dimension of canopy 130. The pivoting frames 140 may include a first frame 140a configured to pivot a first amount between a position collapsed against the base 110 to a first extended position. In an example, first frame 140a forms an opening into the compartment and pivots through an angle of approximately 90 degrees. By its approximate 90-degree pivot, first frame 140a may pivot through between perhaps 87 degrees and 93 degrees and will otherwise appear to pivot through 90 degrees to an ordinary observer.

Frames 140 may include a second frame 140b configured to pivot a second amount less than the first amount between a position collapsed against base 110 to a second extended position. In an example, second frame 140b pivots through an angle of approximately 60 degrees. By its approximate 60-degree pivot, second frame 140b may pivot through between perhaps 57 degrees and 63 degrees and will otherwise appear to pivot through 60 degrees to an ordinary observer.

Frames 140 may include a third frame 140c configured to pivot a third amount less than the second amount between a position collapsed against base 110 to a third extended position. In an example, third frame 140c pivots through an angle of approximately 30 degrees between a first position collapsed against base 110 and a second position. By its approximate 30-degree pivot, third frame 140c may pivot through between perhaps 27 degrees and 33 degrees and will otherwise appear to pivot through 30 degrees to an ordinary observer.

The angle through which each of frames 140 pivots during expansion or collapse of canopy 130 may be an even division of the total pivot angle of the first or furthest pivoting frame by the total number of frames. As such, in a case of five frames, a first frame may still pivot 90 degrees while a second frame pivots 67.5 degrees, a third frame pivots 45 degrees and a fourth frame pivots 22.5 degrees. However, in some examples, the angle of rotation between pairs of frames 140 may not be equal.

Frames 140 may be formed from any of a variety of lightweight, durable, resilient materials including but not limited to lightweight metal, wood, plastic, fiberglass or combinations thereof. In an example, frames 140 may be comprised of a number of rods sewn into sleeves of canopy 130 and sandwiched between two layers of tape. The pet compartment may further include a number of corner reinforcements 150 coupled with frames 140 where leg portions meet bridge portions.

Frames 140 may have a shape matching or partially matching a footprint of base 110 so that they are capable of neatly collapsing onto base 110. In an example, frames 140 may be rectangular to match a rectangular base 110.

Second frame 140b may further include a ceiling extender (not visible) to increase the overall height of the pet compartment allowing some adjustment of compartment size in accordance with pet size.

Referring to FIG. 8, canopy 130 may be formed from a number of hexagons 130a cut from a nylon mesh and merged along their forward and/or rearward edges. The three forward edges of each hexagon may include sleeve-forming flaps 132, 133, 134, while the three rearward edges of each hexagon may include sleeve-forming flaps 135, 137 and 138. Flaps 132, 133, 134, 135, 137 and 138 are configured to receive and hold leg portions and bridge portions of frames 140.

Canopy 130 may wrap around each frame 140 along the first leg portion, across the bridge portion and along the second leg portion. Thus, canopy 130 may include a width approximately equal to the sum of the lengths of two frame leg portions and the length of one the bridge portion. In its approximate equality to the sum of the lengths of the two frame leg portions and the length of one of the bridge portions, the width of canopy 130 may be slightly greater than this sum, for example, by 1-2 inches.

Canopy 130 may include a first continuous edge coupled with front and side edges of base 110 or leg and bridge portions of a passive frame resting on the base 110. Canopy 130 may further include a second continuous edge surrounding an opening at a rear of compartment 100. The two continuous edges come together at two corners near the rear corners of base 110.

Canopy 130 may exhibit a faceted clamshell shape when unfolded and/or may exhibit a faceted half arch in profile. Canopy 130 may include a number of see-through holes 131 and/or a number of small windows. Canopy 130 may be formed from any of a variety of thin, lightweight, flexible materials including but not limited to nylon, polyester, poly-cotton or combinations thereof.

In another embodiment, canopy 130 may further include at least an adjustable port window (not visible).

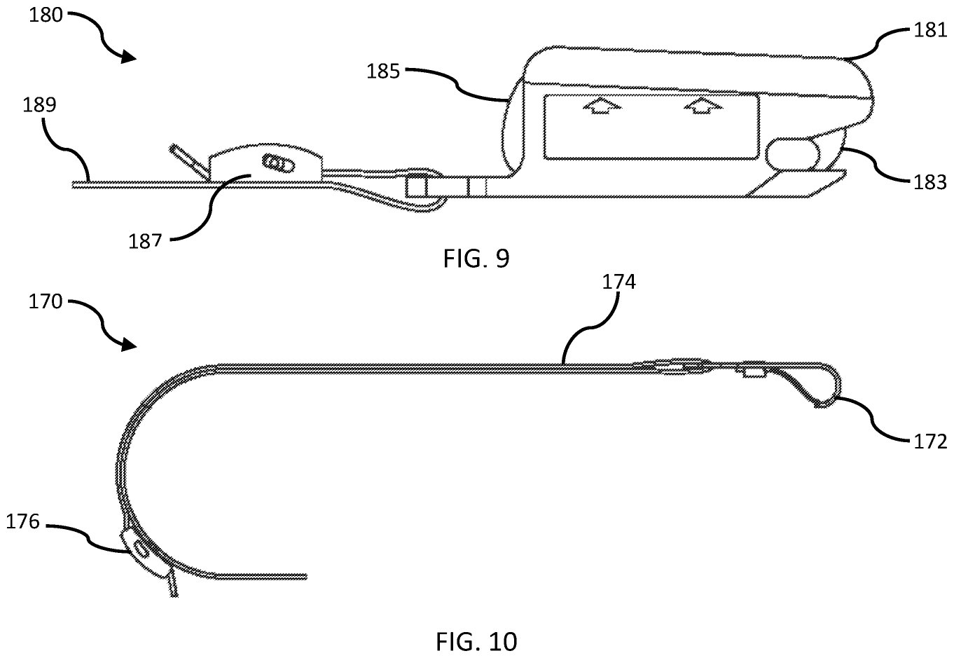

Referring to FIG. 9, the automobile push-type lower anchor connectors 180a and 180b (collectively, 180) are coupled with base 110 at the rear side, for example, by webbing 189. Automobile lower anchor connectors 180 include a first buckle 181 having a gripping hook 183 and a release button 185 so as to be configured to couple with an anchor in the automobile seat bight which might otherwise be used to anchor a child car seat. The distance of the automobile lower anchor connectors from base 110 may be adjustable with a sliding buckle 187 so that pet compartment 100 may be secured to an automobile seat anchor in accordance with the preferred distance and/or in accordance with the preferred amount of constraint on movement of pet compartment 100.

Referring to FIG. 10, hook-type tether connector 170 may be coupled with the bridge portion of one of frames 140 (FIGS. 1-5) and include a hook clip 172 coupled to webbing 174. Distance of the hook clip 172 from the frame to which it is coupled may be adjustable with a buckle 176 to shorten or lengthen webbing 174. The length of webbing 174 may be adjusted in accordance with the distance of the push-type automobile lower anchor connectors from base 110, the preferred distance of pet compartment 100 from the seat back and/or the preferred constraint on movement of the pet compartment.

Disclosed pet enclosures, pet compartments and/or pet cubicles may be produced in accordance with any of a variety of methods. According to an example method, a number of hexagons are cut from a nylon mesh such that each of three forward edges and three rearward edges of each hexagon include sleeve-forming flaps. A rod is sewn into a sleeve formed from each of the flaps of the three rearward edges to form a frame for each of the hexagons with six of the rods providing the frame leg portions and three of the rods providing the frame bridge portions. The hexagons are sewn together at the forward and rearward edges while leaving one free forward edge and one free rearward edge. The three coupled hexagons are formed into a canopy having two generally flat side surfaces and a faceted arch top surface.

A base is provided. The coupled hexagons are pivotably coupled to opposing sides of the base near a rear side thereof such that there is a forward hexagon, a center hexagon and a rearward hexagon. In an example, the ends of the leg portions of the rods and/or frames sewn into the hexagons are constrained in circular segment sleeves or pockets. First and second push-type automobile lower anchor connectors are coupled with the base at a rear side near corners thereof. A hook-type tether connector is coupled with a bridge of the frame of the rearward hexagon.

A corner reinforcement may be applied to two corners formed between the first and second hexagons, to two corners formed between the second and third hexagons and to two corners formed at the rearward edge of the third hexagon.

The method may further include taping inside along the edges between the first and second hexagons and the second and third hexagons and taping outside along the edges between the first and second hexagons and the second and third hexagons. A foam pad may be inserted into a cover and the combination placed into the base.

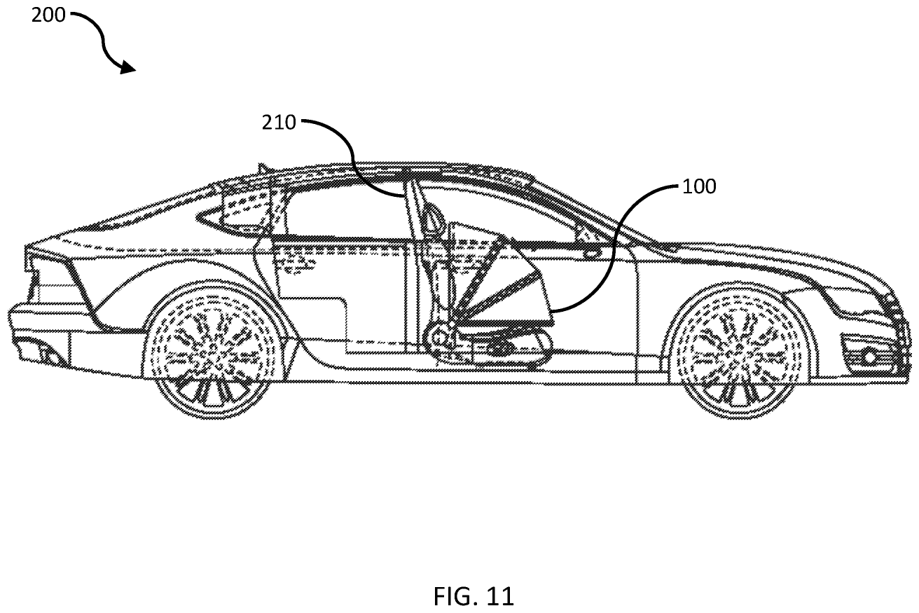

Disclosed pet enclosures, pet compartments and/or pet cubicles may be suitable for any of a variety of methods for installing the same in an automobile. In an example method, a base is placed on a seat of an automobile with a rear edge thereof adjacent to the seat back, first and second anchor connectors are coupled to anchors of the seat, a pet is placed on the base and a canopy is unfolded to cover the pet while leaving an opening above the rear edge of the base. Unfolding the canopy may further include rotating a first frame about 30 degrees, a second frame about 60 degrees and a third frame about 90 degrees. A tether connector is coupled to an anchor point such as an automobile headrest post. FIG. 11 illustrates a hidden lines side view of an example pet enclosure, pet compartment or pet cubicle as installed in an automobile.

Embodiments of the disclosure are susceptible to being used for various purposes, including, though not limited to, enabling users to transport a pet in or on an automobile seat in a manner that is safe for both the user and the pet while preventing damage to the automobile interior from stains and/or tears.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the disclosure are intended to be construed in a non-exclusive manner, namely allowing for items, components or elements not explicitly described also to be present. Reference to the singular is also to be construed to relate to the plural.

1. A pet compartment, comprising:
a base;
a plurality of frames each including leg portions pivotably coupled with opposing sides of the base near a rear side of the base and bridge portions spanning the leg portions;
a canopy supported by the frames so as to fold and unfold upon relative pivoting of the frames;
a plurality of automobile anchor connectors coupled with the base at the rear side; and
a tether connector coupled with the bridge of one of the frames.

2. The pet compartment as set forth in claim 1, wherein the frames have a shape partially matching with a footprint of the base.

3. The pet compartment as set forth in claim 1, wherein the frames have a common pivot axis.

4. The pet compartment as set forth in claim 1, wherein pivoting of each of the frames is limited according to where the frames are coupled along a length of the canopy.

5. The pet compartment as set forth in claim 1, wherein the canopy wraps around each frame along a first leg portion, across the bridge portion and along the second leg portion.

6. The pet compartment as set forth in claim 1, wherein the canopy includes a plurality of see-through holes.

7. The pet compartment as set forth in claim 1, wherein the canopy includes a plurality of small windows.

8. The pet compartment as set forth in claim 1, wherein the canopy comprises a first continuous edge coupled with front and side edges of the base and a second continuous edge surrounding an opening at a rear of the base.

9. The pet compartment as set forth in claim 1, wherein the canopy exhibits a faceted clamshell shape when unfolded.

10. The pet compartment as set forth in claim 1, wherein the canopy exhibits a faceted half arch in profile when unfolded.

11. The pet compartment as set forth in claim 1, wherein a distance of the automobile anchor connectors from the base is adjustable.

12. The pet compartment as set forth in claim 1, wherein a distance of the tether connector from the frame is adjustable.

13. The pet compartment as set forth in claim 1, further comprising a plurality of corner reinforcements coupled with the frames where leg portions meet bridge portions.

14. A pet enclosure, comprising:
a base;
a collapsible canopy configured for suspending above the base;
a plurality of automobile anchor connectors configured for coupling with the base at the rear side; and
a tether connector configured for coupling with the collapsible canopy.

15. The pet enclosure as set forth in claim 14, further comprising a plurality of pivoting frames configured to suspend the collapsible canopy above the base.

16. The pet enclosure as set forth in claim 15, wherein the pivoting frames comprise a first frame configured to pivot a first amount between a position collapsed against the base to a first extended position.

17. The pet enclosure as set forth in claim 16, wherein the frames comprise a second frame configured to pivot second amount less than the first amount between a position collapsed against the base to a second extended position.

18. The pet enclosure as set forth in claim 17, wherein the frames comprise a third frame configured to pivot a third amount less than the second amount between a position collapsed against the base to a third extended position.

19. A method for producing a pet compartment, comprising:
cutting a plurality of hexagons from a nylon mesh such that each of three forward edges and three rearward edges of each hexagon includes a sleeve-forming flap;
sewing a rod into a sleeve formed from each of the flaps of the three rearward edges to form a frame for each of the hexagons;
sewing the hexagons together at the forward and rearward edges while leaving one free forward edge and one free rearward edge;
folding the three sewn hexagons into a canopy having two generally flat side surfaces and a faceted arch top surface;
providing a base;
pivotably coupling the sewn hexagons to opposing sides of the base near a rear side thereof such that there is a forward hexagon, a center hexagon and a rearward hexagon;
coupling first and second automobile anchor connectors with the base at a rear side near corners thereof; and
coupling a tether connector with a bridge of the frame of the rearward hexagon.

20. The method as set forth in claim 19, further comprising placing a foam pad inside a cover and placing into the base.

21. The pet compartment as set forth in claim 1, wherein the canopy is comprised of a plurality of nylon mesh hexagons.

22. The pet enclosure as set forth in claim 14, wherein the canopy is comprised of a plurality of nylon mesh hexagons.
